(19) United States
(12) Patent Application Publication
(10) Pub. No.: US 2016/0167214 A1
(43) Pub. Date: Jun. 16, 2016

(54) PAINT CAN UTILITY TOOL

(71) Applicants: Carole Lynn Craig, Toledo, OH (US); Robert Allen Craig, Toledo, OH (US)

(72) Inventors: Carole Lynn Craig, Toledo, OH (US); Robert Allen Craig, Toledo, OH (US)

(21) Appl. No.: 14/965,993

(22) Filed: Dec. 11, 2015

Related U.S. Application Data
(60) Provisional application No. 62/090,897, filed on Dec. 12, 2014.

(51) Int. Cl. B25F 1/00

(52) U.S. Cl. CPC B25F 1/006

(57) ABSTRACT

A utility tool for removal and sealing of a lid of a container includes a handle having a first end and a second end. A hook is disposed at the first end of the handle. The hook is configured for prying the lid from the container. A mallet portion is disposed at the second end of the handle.

### CROSS-REFERENCE TO RELATED APPLICATIONS

This application claims the benefit of U.S. Provisional Patent Application Ser. No. 62/090,897, filed on Dec. 12, 2014. The entire disclosure of the above patent application is hereby incorporated herein by reference.

### FIELD OF THE INVENTION

The invention relates to a utility tool and more particularly to a utility tool to facilitate removing and sealing lids of containers.

### BACKGROUND OF THE INVENTION

As is commonly known, tools exist to remove lids from containers such as paint cans or pails and tools exist to seal lids to the containers. For example, screw drivers, putty knives, or elongate straight pieces of metal are tools often used to pry the lid from the containers. To pry the lid from the containers, the tool is inserted between the lid and an edge or a sealing rim of the container along several locations around the container to disengage the lid from the container. Additionally, items such as hammers or mallets are typically employed for sealing the lid to the container. To seal the lid to the container, the hammer or mallet is used to impact concentrated portions of the lid against the edge or sealing rim of the container. The pressure resulting from the impact facilitates an engagement of the lid with the sealing rim or edge of the container which, in turn, seals the lid to the container.

Disadvantageously, however, the tools known can cause damage to the lid and/or the sealing rim or the edge of the container. The damage causes the lid to ineffectively seal to the container. An ineffective seal may cause contents contained within the container to spoil, dry out, or otherwise become defective. Additionally, the tools can be complex, ergonomically inefficient, or unsafe to use such as upon repetitive use or upon an undesired slipping of the tool from the hand or container. Furthermore, the tools for removing lids from containers are typically separate and individualized components from the tools for sealing lids to the containers. Transporting multiple separate tools can be undesirable for many applications.

It would therefore be desirable to provide a utility tool configured for both removal of a lid from a container and sealing of the lid to the container, wherein damage to the container is minimized while ergonomic efficiency, simplicity, and safety are maximized.

### SUMMARY OF THE INVENTION

In accordance and attuned with the present invention, a utility tool configured for both removal of a lid from a container and sealing of the lid to the container, wherein damage to the container is minimized while ergonomic efficiency, simplicity, and safety are maximized.

According to an embodiment of the disclosure, a utility tool for removal and sealing of a lid of a container is disclosed. The utility tool includes a handle having a first end and a second end. A hook is disposed at the first end of the handle. The hook is configured to cooperate with the lid to remove the lid from the container. A mallet portion formed at the second end of the handle.

According to another embodiment of the invention, a utility tool for removal and sealing of a lid of a container is disclosed. The utility tool includes a handle having a first end and a second end. The handle has a contoured surface. A hook extends axially outwardly from the first end of the handle. The hook configured to cooperate with the lid to remove the lid from the container. A mallet portion formed at the second end of the handle.

According to yet another embodiment of the invention, a utility tool for removal and sealing of a lid of a container includes a handle having a first end and a second end. The handle has a contoured surface. A hook extends axially outwardly from the first end of the handle. A mallet portion is formed at the second end of the handle. The mallet portion has a substantially planar surface. A reinforcement layer is disposed on the substantially planar surface of the mallet portion.

### BRIEF DESCRIPTION OF THE DRAWINGS

The above, as well as other objects and advantages of the invention, will become readily apparent to those skilled in the art from reading the following detailed description of an embodiment of the invention when considered in the light of the accompanying drawing which:

FIG. 1 is a top perspective view of a utility tool according to an embodiment of the disclosure;

FIG. 2 is an enlarged fragmentary front elevational view of a mallet portion of the utility tool of FIG. 1;

FIG. 3 is a front elevational view of a utility tool according to another embodiment of the disclosure; and

FIG. 4 is a front elevational view of a utility tool according to another embodiment of the disclosure.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner

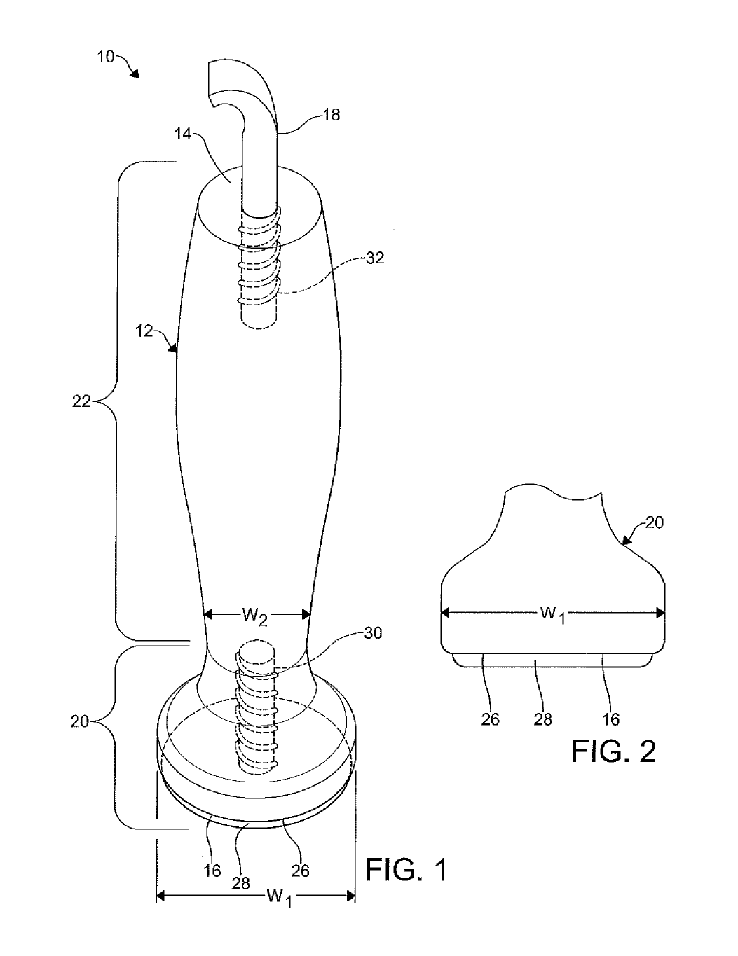

FIGS. 1-2 illustrate a portable utility tool 10. The utility tool 10 is configured to facilitate both removal of a lid from a container and resealing of the lid to the container. The utility tool 10 includes a handle 12 having a first end 14 and a second end 16. A hook 18 is disposed at the first end 14 of the handle 12 and a mallet portion 20 is formed at the second end 16 of the handle 12.

The handle 12 has a contoured surface, wherein a width of the handle 12 varies along a length thereof. For example, in the illustrated embodiment, the handle 12 has an undulating contoured surface configured to fit a hand of a user and facilitate gripping and ergonomic use of the utility tool 10. A gripping portion 22 of the handle 12 adjacent the first end 14 of the handle 12 has a substantially biconvex cylindrical shape and the mallet portion 20 of the handle 12 is substantially flared with respect of the gripping portion 22 of the handle 12. The gripping portion 22 cooperates with the mallet portion 20 to form an annular recess to further facilitate the gripping and the ergonomic use of the utility tool 10.

However, it is understood the handle 12 can have any undulate shape or any other non-undulate shape as desired to facilitate gripping and ergonomic use. For example, the handle 12 can have an undulating contoured surface forming more than one annular recess. The handle 12 could also have any cross-sectional shape such as rectangular, triangular, circular, ovular, oblong, conical, polygonal, any other cross-sectional shape as desired or any combination thereof. Additionally, the surface of the handle 12 can include surface features such as dimples, protuberances, surface roughening, textured materials, or similar surface features configured to facilitate gripping, if desired. The handle 12 can be formed from a durable material such as wood, plastic, metal, or glass for example.

As shown, the mallet portion 20 is monolithically formed and integrated with the handle 12. However, in other embodiments, the mallet portion 20 can be separate from the handle 12 and coupled thereto by threaded fasteners, bolts, screws, a welding process, an adhesive, a friction fit, or any other coupling means as desired. The mallet portion 20 can be formed from the same material as or a different material from the handle 12. For example, the handle 12 can be formed from a wood material and the mallet portion 20 can be formed from a metal material.

The mallet portion 20 has a substantially planar surface 26 formed thereon. A width w₁ of the mallet portion 20 is greater than a width w₂ of a section of the handle 12 adjacent the mallet portion 20 to facilitate the gripping and the ergonomic use of the utility tool 10. However, if desired, the width w₁ of the mallet portion 20 can be equal to or less than the width w₂ of the section of the handle 12 adjacent the mallet portion 20. The mallet portion 20 cooperates with the surface 26 to form a base to support and position the utility tool 10 on a surface for storage. The mallet portion 20 is configured to engage the lid of the container to seal the lid to the container.

In the embodiment illustrated, the utility tool 10 includes a reinforcement layer 28 disposed on the surface 26 of the mallet portion 20. The reinforcement layer 28 is formed from a material configured to minimize damage to the utility tool 10, the lid of the container, and/or the container. For example, the reinforcement layer 28 can be formed from a durable and rigid metal plate, washer, or metallic coating to minimize damage to the handle 12. In another example, the reinforcement layer 28 can be formed from a rigid plastic, a wood, or a ceramic. In yet another example, the reinforcement layer 28 can be formed from a material with elastic or visco-elastic properties to absorb impact forces created between the utility tool 10 and the container during engagement there between. The elastic or visco-elastic material can be a foam, a rubber, a shape memory metal, an elastomer, or a combination thereof, for example. The reinforcement layer 28 is coupled to the mallet portion 20 by a threaded fastener 30. However, the reinforcement layer 28 can be coated on the mallet portion 20 or coupled to the mallet portion 20 by any coupling means as desired such as bolts, screws, a welding process, an adhesive, a friction fit, or any other coupling means as desired.

The hook 18 extends axially outwardly from the first end 14 of the handle 12. The hook 18 is configured to facilitate prying and removal of the lid from the container. In the illustrated embodiment, the hook 18 is coupled to the handle 12 by a threaded fastener 32. However, the hook 18 can be coupled to the handle 12 by any coupling means as desired such as bolts, screws, a welding process, an adhesive, or a friction fit, for example. Additionally, the hook 18 can be monolithically formed with the handle 12 or separate from and coupled to the handle 12 during a molding or forming process. The hook 18 cooperates with the handle 12 to facilitate prying of the lid from the container.

The utility tool 10 can be manufactured by any process as desired. For example, the first portion 22 of the handle 12, the mallet portion 20 of the handle 12, and the hook 18 can be formed integrally with each other with similar materials or varying materials by any process as desired such as a molding process, a forming process, a cutting process, or a 3D printing process, for example. Although, other processes and materials can be used, as desired.

A user employs the utility tool 10 to both pry and remove the lid from the container and seal the lid to the container. The utility tool 10 is particularly effective with containers such as paint cans and pails (for example, 1-gallon cans, 1-quart cans, and ½-pint cans). Although, it is understood the utility tool 10 can be employed with other known containers, if applicable. In use, to pry and remove the lid from the container, the user grips the utility tool 10 at the gripping portion 22 and positions the hook 18 between the lid and an edge or a sealing rim of the container. With a prying motion or pivot about the first end of the handle 12 and using the handle 12 as a lever, the hook 18 urges the lid away from the container until the lid disengages from the edge or the sealing rim of the container. The process may be repeated at several locations along the circumference of the lid if necessary to cause the lid to be removed from the container. The hook 18, as opposed to a flat surface of a screw driver, for example, minimizes denting or other damage to the rim and/or the container when prying the lid from the container. Once the lid is free from the container, the user can remove the lid from the container. The undulating contour of the handle 12 facilitates gripping during the prying of the lid.

To seal the lid to the container, the user grips the utility tool 10 at the gripping portion 22. With a striking motion, the user causes the mallet portion 20 to impact portions of the lid. The utility tool 10 is positioned to cause the surface 26 and/or reinforcement layer 28 to contact the lid and/or the container upon impact. Advantageously, the undulating contour of the handle 12 facilitates gripping the utility tool 10 during striking and impact. Additionally, the larger width w₁ of the mallet portion 20 with respect to the section of the handle 12 adjacent the mallet portion 20 militates against a hand of the user slipping towards the container during impact, thus acting as a barrier to the hand being pinched or contacted. The force resulting from the impact facilitates an engagement of the lid with the sealing rim or edge of the container which, in turn, seals the lid to the container.

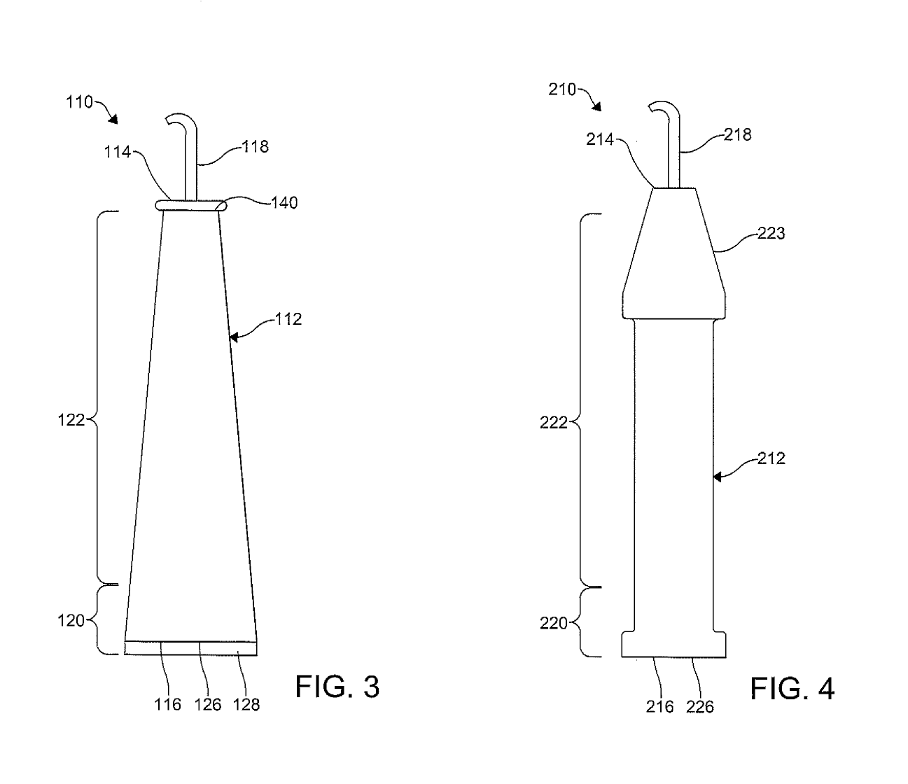

The utility tool 10 can have other configurations as desired. The utility tool 10 shown in FIGS. 1-2 is an exemplary embodiment. For example, the utility tool 10 can have other handle configurations and mallet portion configurations. In FIG. 3, a utility tool 110 according to another exemplary embodiment of the disclosure is shown. Features similar to the features illustrated in FIGS. 1-2 are denoted with the same reference numeral with a leading “1” before the reference numeral for clarity. The utility tool 110 of FIG. 3 is substantially similar to and employed in substantially the same manner as the utility tool 10 of FIGS. 1-2 except the handle 112 continuously tapers from the second end 116 towards the first end 114. A portion of the handle 112 adjacent the second end 116 forms the mallet portion 120. In the embodiment illustrated, the mallet portion 120 includes a reinforcement layer 228. However, the mallet portion 120 can be free from a reinforcement layer 228, if desired. Additionally, a flange 140 is disposed at the first end 114 of the handle 112 to support and strengthen the hook 118 and the first end 114 of the handle 112.

FIG. 4 illustrates a utility tool 210 according to yet another embodiment of the disclosure. Features similar to the features illustrated in FIGS. 1-2 are denoted with the same reference numeral with a leading “2” before the reference numeral for clarity. The utility tool 210 of FIG. 4 is substantially similar to and employed in a substantially similar manner to the utility tool 10 of FIGS. 1-2 except the handle 212 includes a head portion 223 in addition to the gripping portion 222 and the mallet portion 220. The head portion 223 is disposed adjacent the first end 214 of the handle 212. The head portion 223 tapers from the gripping portion 222 towards the first end 214 of the handle 212. The gripping portion 222 is recessed with respect to the head portion 223 and the mallet portion 220. The recessed gripping portion 222 militates against the hand of the user slipping during used of the utility tool 210 and facilitates gripping of the utility tool 210.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A utility tool for removal and resealing of a lid of a container comprising:
a handle having a first end and a second end;
a hook disposed at the first end of the handle, the hook configured to cooperate with the lid to remove the lid from the container; and
a mallet portion formed at the second end of the handle.

2. The utility tool of claim 1, wherein the handle has a contoured surface.

3. The utility tool of claim 2, wherein the contoured surface is undulating.

4. The utility tool of claim 1, wherein the handle tapers from the second end towards the first end thereof.

5. The utility tool of claim 1, wherein the handle includes a recessed gripping portion.

6. The utility tool of claim 1, wherein the hook extends axially outwardly from the first end of the handle.

7. The utility tool of claim 1, wherein a threaded fastener couples the hook to the handle.

8. The utility tool of claim 1, wherein the mallet portion is monolithically formed with the handle.

9. The utility tool of claim 1, wherein the mallet portion is formed separate from the handle and coupled to the handle.

10. The utility tool of claim 1, wherein the mallet portion has a substantially planar surface formed thereon.

11. The utility tool of claim 10, wherein a reinforcement layer is disposed on the substantially planar surface of the mallet portion.

12. The utility tool of claim 1, wherein a threaded fastener couples a reinforcement layer to the mallet portion.

13. The utility tool of claim 1, wherein a width of the mallet portion is greater than a width of a section of the handle adjacent the mallet portion.

14. A utility tool for removal and sealing of a lid of a container comprising:
a handle having a first end and a second end, the handle having a contoured surface;
a hook extending axially outwardly from the first end of the handle, the hook configured to cooperate with the lid to remove the lid from the container; and
a mallet portion formed at the second end of the handle.

15. The utility tool of claim 14, wherein the handle has at least one of an undulating contoured surface, a portion tapering from the second end towards the first end thereof, and a recessed gripping portion.

16. The utility tool of claim 14, wherein a width of the mallet portion is greater than a width of a section of the handle adjacent the mallet portion.

17. The utility tool of claim 14, wherein the mallet portion is monolithically formed with the handle.

18. The utility tool of claim 14, wherein the mallet portion is formed separate from the handle and coupled to the handle.

19. The utility tool of claim 14, wherein the mallet portion has a substantially planar surface formed thereon and a reinforcement layer disposed on the substantially planar surface of the mallet portion.

20. A utility tool for removal and sealing of a lid of a container comprising:
a handle having a first end and a second end, the handle having a contoured surface;
a hook extending axially outwardly from the first end of the handle;
a mallet portion formed at the second end of the handle, the mallet portion having a substantially planar surface; and
a reinforcement layer disposed on the substantially planar surface of the mallet portion.
